(19) United States
(12) Patent Application Publication
(10) Pub. No.: US 2025/0053890 A1
(43) Pub. Date: Feb. 13, 2025

(54) SERVICE RESERVATION INCLUDING BIOMETRIC USER AUTHENTICATION

(71) Applicant: NEC Corporation, Tokyo (JP)

(72) Inventors: Tomohiro Yamaguchi, Tokyo (JP); Yuki Ikeda, Tokyo (JP); Takeyoshi Oe, Tokyo (JP); Yusuke Miyamoto, Tokyo (JP); Saki Kato, Tokyo (JP)

(73) Assignee: NEC Corporation, Tokyo (JP)

(21) Appl. No.: 18/928,237

(22) Filed: Oct. 28, 2024

Related U.S. Application Data
(63) Continuation of application No. 18/022,686, filed on Feb. 22, 2023.

(51) Int. Cl. G06Q 10/02; G06F 21/32; G06Q 50/12; G06V 40/16

(52) U.S. Cl. CPC G06Q 10/02; G06F 21/32; G06Q 50/12; G06V 40/171; G06V 40/172; G06Q 2220/00

(57) ABSTRACT

A server (100) that facilitates a user to register biometric information is provided. The server (100) includes an acquisition unit (101) and a reservation management unit (102). The acquisition unit (101) is configured to acquire, from a user's terminal, reservation information about a reservation for a service provided using biometric authentication. The reservation management unit (102) is configured to determine whether or not to accept the reservation for the service based on the reservation information. When the reservation management unit (102) determines to accept the reservation for the service, the reservation management unit (102) transmits, to the terminal, a reservation completion notice including introduction information about installation of an application for registering information necessary for the biometric authentication.

This application is a Continuation of U.S. application Ser. No. 18/022,686 filed on Feb. 22, 2023, which is a National Stage Entry of PCT/JP2020/036874 filed on Sep. 29, 2020, the contents of all of which are incorporated herein by reference, in their entirety.

### TECHNICAL FIELD

The present disclosure relates to a server, a system, a server control method, and a storage media.

### BACKGROUND ART

In recent years, various services using biometric information have begun to become widespread. For example, facial recognition is used for various procedures (check-in, baggage check-in, etc.) at airports and hotel check-ins.

For example, Patent Literature 1 discloses a vacation rental management server in a vacation rental service system that uses a video of a person captured with a mobile terminal to verify the identity of a guest and unlock a room key.

### CITATION LIST

### Patent Literature

Patent Literature: Japanese Unexamined Patent Application Publication No. 2018-101235

### SUMMARY OF INVENTION

### Technical Problem

As mentioned above, services using biometric authentication have begun to become widespread. In order to receive a service using biometric authentication, a user needs to register his/her biometric information (face image) in an authentication server or the like. However, users do not know how to register biometric information, which is one of the factors hindering the spread of services using the biometric information.

A main object of the present disclosure is to provide a server, a system, a server control method, and a storage media that contribute to facilitating a user to register biometric information.

### Solution to Problem

In a first example aspect of the present disclosure, a server including: an acquisition unit configured to acquire, from a user's terminal, reservation information about a reservation for a service provided using biometric authentication; and a reservation management unit configured to determine whether or not to accept the reservation for the service based on the reservation information, and when the reservation management unit determines to accept the reservation for the service, the reservation management unit transmits, to the terminal, a reservation completion notice including introduction information about installation of an application for registering information necessary for the biometric authentication is provided.

In a second example aspect of the present disclosure, a system including: a terminal used by a user; an authentication server configured to perform biometric authentication using biometric information; and a server connected to the authentication server, where the server includes: an acquisition unit configured to acquire, from a user's terminal, reservation information about a reservation for a service provided using the biometric authentication; and a reservation management unit configured to determine whether or not to accept the reservation for the service based on the reservation information, and when the reservation management unit determines to accept the reservation for the service, the reservation management unit transmits, to the terminal, a reservation completion notice including introduction information about installation of an application for registering information necessary for the biometric authentication is provided.

In a third example aspect of the present disclosure, a method of controlling a server including: acquiring, from a user's terminal, reservation information about a reservation for a service provided using biometric authentication; and determining whether or not to accept the reservation for the service based on the reservation information, and when the reservation management unit determines to accept the reservation for the service, the reservation management unit transmits, to the terminal, a reservation completion notice including introduction information about installation of an application for registering information necessary for the biometric authentication is provided.

In a fourth example aspect of the present disclosure, a non-transitory computer readable medium storing a program for causing a computer mounted on a server to execute: processing of acquiring, from a user's terminal, reservation information about a reservation for a service provided using biometric authentication; and processing of determining whether or not to accept the reservation for the service based on the reservation information, and when the reservation management unit determines to accept the reservation for the service, the reservation management unit transmits, to the terminal, a reservation completion notice including introduction information about installation of an application for registering information necessary for the biometric authentication is provided.

### Advantageous Effects of Invention

According to the respective example aspects of the present disclosure, a server, a system, a server control method, and a storage media that contribute to facilitating a user to register biometric information are provided. The effect of the present disclosure is not limited to the above. With the present disclosure, other effects may be exerted in place of or in conjunction with such effects.

### BRIEF DESCRIPTION OF DRAWINGS

FIG. 1 is a diagram for describing an overview of one example embodiment;

FIG. 2 shows an example of a schematic configuration of an authentication system according to a first example embodiment;

FIG. 3 is a diagram for describing an operation of the authentication system according to the first example embodiment;

FIG. 4 is a diagram for describing the operation of the authentication system according to the first example embodiment;

FIG. 5 is a diagram for describing the operation of the authentication system according to the first example embodiment;

FIG. 6 is a diagram for describing the operation of the authentication system according to the first example embodiment;

FIG. 7 is a diagram for describing the operation of the authentication system according to the first example embodiment;

FIG. 8 is a diagram for describing the operation of the authentication system according to the first example embodiment;

FIG. 9 is a diagram for describing the operation of the authentication system according to the first example embodiment;

FIG. 10 is a diagram for describing the operation of the authentication system according to the first example embodiment;

FIG. 11 shows an example of a processing configuration of the authentication server according to the first example embodiment;

FIG. 12 shows an example of an authentication information database according to the first example embodiment;

FIG. 13 shows an example of a processing configuration of a hotel server according to the first example embodiment;

FIG. 14 shows an example of a reservation information database according to the first example embodiment;

FIG. 15 shows an example of a processing configuration of an authentication terminal according to the first example embodiment;

FIG. 16 shows an example of a processing configuration of a terminal according to the first example embodiment;

FIG. 17 is a flowchart showing an example of an operation of the authentication system according to the first example embodiment;

FIG. 18 is a flowchart showing an example of an operation of an authentication system according to a second example embodiment;

FIG. 19 shows an example of a hardware configuration of a hotel server; and

FIG. 20 shows an example of a schematic configuration of an authentication system according to a modified example of the present disclosure.

### EXAMPLE EMBODIMENT

First, an overview of one example embodiment is described. The reference signs in the drawings added to this overview are added to elements for convenience as an example to aid understanding, and the descriptions in this overview are not intended to be limiting in any way. In the absence of a specific description, each of the blocks described in the drawings represents a functional unit rather than a hardware unit. The connecting lines between the blocks in each drawing include both bidirectional and unidirectional. One-way arrows schematically indicate flows of main signals (data) and do not exclude bidirectionality. For elements that can be similarly described in the present specification and drawings, repeated descriptions may be omitted by attaching identical signs.

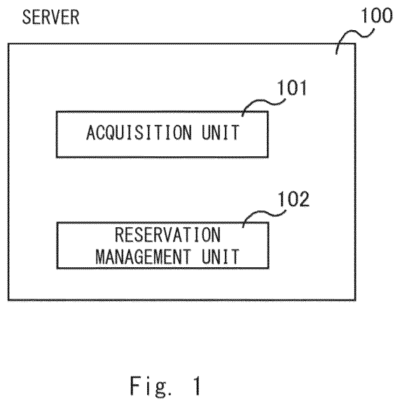

A server 100 according to one example embodiment includes an acquisition unit 101 and a reservation management unit 102 (see FIG. 1). The acquisition unit 101 acquires reservation information about a reservation for a service provided using biometric authentication from a user's terminal. The reservation management unit 102 determines whether or not to accept the reservation for the service based on the reservation information. When the reservation management unit 102 accepts the reservation for the service, it transmits a reservation completion notice to the terminal. The reservation completion notice includes introduction information about installation of an application for registering information required for the biometric authentication.

When the server 100 accepts the user's reservation, it notifies the user of information about the application for registering the information necessary for the biometric authentication. The user can install the application on the terminal according to the information the user is notified of (e.g., URL for a download site of the above application). That is, the user does not need to search for an application to register the biometric information, and can easily register the biometric information in a certificate authority.

Specific example embodiments are described below in more detail with reference to the drawings.

### First Example Embodiment

A first example embodiment is described in more detail with drawings.

### [System Configuration]

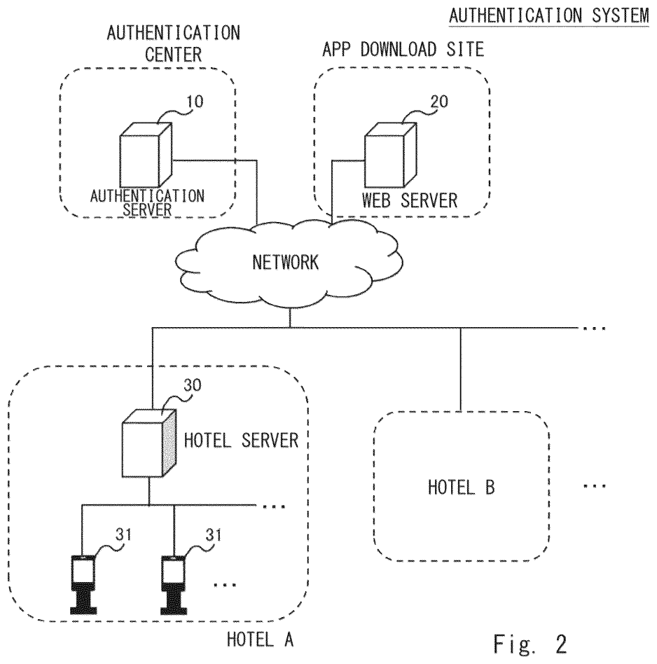

FIG. 2 shows an example of a schematic configuration of an authentication system according to the first example embodiment. Referring to FIG. 2, the authentication system includes an authentication center, an application (APP; Application) download site, and a plurality of service providers.

The service providers are those that provide services to users by using the biometric authentication. The following discussion is based on an example of accommodation providers as the service providers.

The authentication center provides authentication services to accommodation providers (hotels) participating in a system. At least one or more authentication servers 10 are installed in the authentication center. The authentication server 10 operates as a certificate authority for the biometric authentication using the biometric information. The authentication server 10 may be installed at the site of the authentication center or in the cloud.

Examples of the user's biometric information include data (feature quantities) calculated from physical characteristics unique to the individual, such as a face, a fingerprint, a voiceprint, a vein, a retina, and an iris pattern of a pupil. Alternatively, the biometric information of the user may be image data such as a face image or a fingerprint image. The biometric information of the user may include the physical characteristics of the user as information.

The authentication server 10 processes the “authentication request” transmitted from each hotel and returns a result of the authentication processing to a transmitter of the authentication request.

The application download site provides applications that run on a smartphone or personal computer. The application download site may be operated by an Information Technology (IT) company or by a management body of the authentication center.

Users can obtain various applications (software) by accessing the application download site.

The application download site includes at least one Web (Web) server 20. The Web server 20 is configured to store various application programs and to download application programs requested by the user.

The hotel shown in FIG. 2 supports biometric authentication. Specifically, the user is identified by biometric authentication and is provided with accommodation services, etc.

Each hotel participating in the system includes a hotel server 30 and at least one authentication terminal 31. A configuration of each of the plurality of hotels included in the authentication system can be identical. Therefore, in the following description, the configuration of a hotel A will be described and the configurations of other hotels will be omitted.

The hotel server 30 controls and manages the overall business of the accommodation providers. For example, the hotel server 30 performs processing related to a user's accommodation reservation and processing related to check-in and check-out.

The hotel server 30 includes control and management functions related to biometric authentication of users in addition to the above functions related to check-in and so on.

The authentication terminal 31 is an apparatus that serves as an interface for the user (guest) visiting the hotel. The user receives various services through the authentication terminal 31. For example, the authentication terminal 31 is installed in a hotel lobby or the like. The user performs check-in and check-out procedures by using the authentication terminal 31. Alternatively, the authentication terminal 31 may be installed in front of a guest room and used to manage entry to and exit from each room.

The apparatuses shown in FIG. 2 are connected to each other. For example, the authentication server 10 and the hotel server 30 are connected by wired or wireless communication means and configured to enable mutual communication.

The configuration shown in FIG. 2 is an example and is not intended to limit the configuration of the authentication system disclosed in the present application. For example, the authentication center may include two or more authentication servers 10. Alternatively, each hotel may include at least one authentication terminal 31. Further alternatively, the functions of the hotel server 30 and the authentication terminal 31 may be integrated and accommodation services may be provided by one such integrated apparatus. In yet another alternative, in each hotel, the plurality of authentication terminals 31 may be connected to one hotel server 30 as shown in FIG. 2, or one authentication terminal 31 may be connected to one hotel server 30.

### [System Operation Overview]

Next, an operation overview of the authentication system according to the first example embodiment is described.

### [Hotel Reservations]

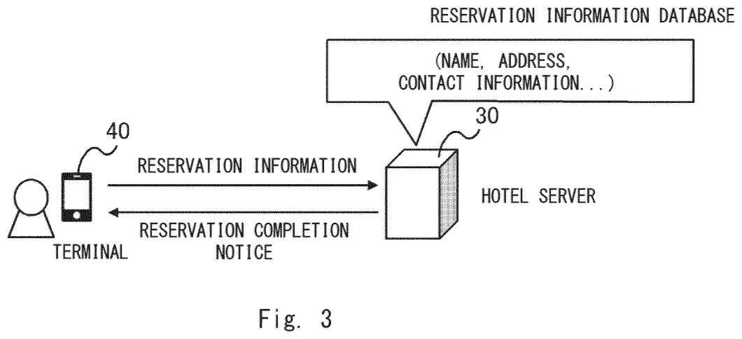

A user wishing to use a hotel makes a hotel reservation in advance by using a terminal 40 (see FIG. 3). Examples of the terminal 40 include a mobile terminal apparatus such as a smartphone, a mobile phone, a game machine, a tablet, or a computer (personal computer and laptop).

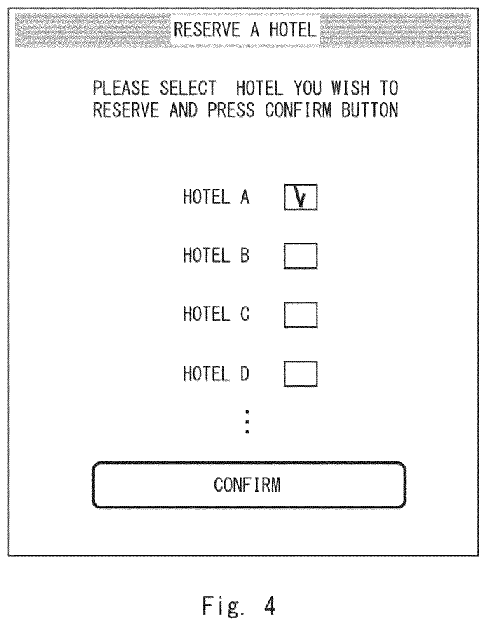

The terminal 40 displays a Graphical User Interface (GUI) that enables the user to select the hotel for which he/she makes a reservation in response to the user's operation. For example, the terminal 40 displays a GUI as shown in FIG. 4 and acquires information about the hotel for which the user wishes to make a reservation.

The terminal 40 accesses the hotel server 30 of the hotel selected by the user. For example, when the terminal 40 makes a reservation for the hotel A shown in FIG. 2, it accesses the hotel server 30.

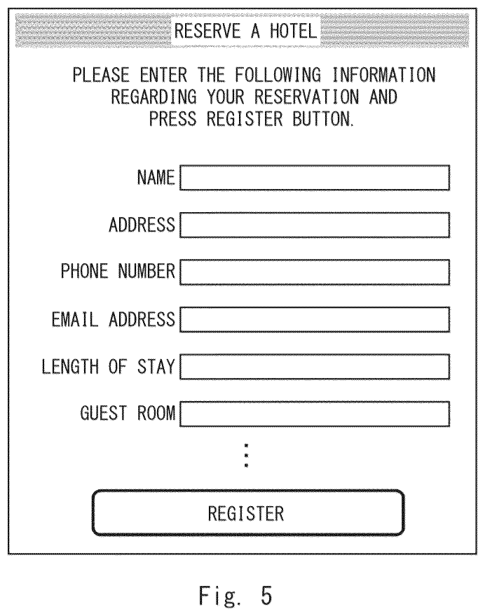

The user operates the terminal 40 to input the reservation information into the hotel server 30. Specifically, the terminal 40 acquires the reservation information by using a GUI as shown in FIG. 5. Examples of the reservation information include a name, an address, contact information (phone number, email address), a length of stay, and a guest room preference (guest room grade). The terminal 40 transmits the acquired reservation information to the hotel server 30.

In this way, the terminal 40 registers the reservation information including the name, address, and the like to the hotel server 30 to be included in a registration card.

The hotel server 30 determines whether or not to accept the reservation based on the acquired reservation information. Specifically, the hotel server 30 determines whether or not to accept the user's reservation based on a vacancy status or the like for the desired length of stay.

When the hotel server 30 accepts the user's reservation, it stores the reservation information acquired from the user in a reservation information database (see FIG. 3). Furthermore, the hotel server 30 transmits a “reservation completion notice” to the contact information input by the user. More specifically, the hotel server 30 transmits a reservation completion email to an email address that the terminal 40 used by the user can receive.

The user receives the reservation completion notice (reservation completion email) using the terminal 40.

The reservation completion notice includes detailed information about the reservation (name of a person making a reservation (such a person will be hereinafter referred to as a reserving person), a length of stay, etc.), as well as information about the user registration app.

The user registration app is an application for registering information (biometric information and user information) required to receive services by biometric authentication at the authentication center.

The information about the user registration app is for introducing (installing) the app to the terminal 40. In the following descriptions, information about the user registration app is referred to as “user registration app introduction information”.

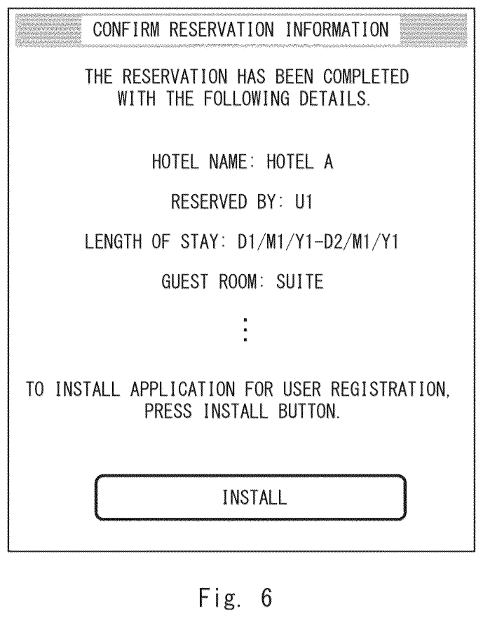

The terminal 40 generates a display based on the reservation completion notice and presents it to the user. For example, the terminal 40 displays the screen as shown in FIG. 6.

The user checks the displayed details. When the user wishes to install the user registration app, the user presses the “Install” button displayed in FIG. 6.

### [Installing User Registration App]

By detecting a press of the install button, the terminal 40 performs processing related to the installation of the user registration app.

Specifically, the user registration app is installed on the terminal 40 based on the user registration app introduction information. An example of a Uniform Resource Locator (URL) indicating a location of a download site (landing page) providing the user registration app is shown in the user registration app introduction information.

When the user chooses to install the user registration app, the terminal 40 accesses the URL transmitted by the hotel server 30. Since the URL corresponds to the address of the download site of the Web server 20, the terminal 40 can acquire the user registration app from the Web server 20. After that, the user registration app can be installed on the terminal 40.

### [User Registration]

After the installation of the user registration app is completed, the user goes through the procedure to receive the service using the biometric authentication. Specifically, the user starts the user registration app installed on the terminal 40. The user uses the user registration app to input information about the user who has made a reservation for a hotel (user information or reserving person information) into the authentication server 10.

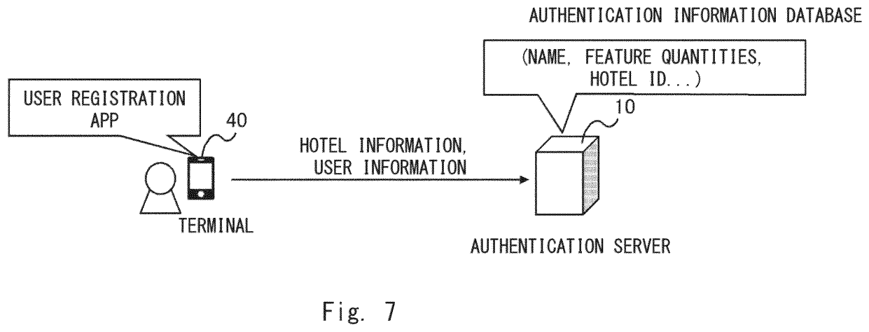

Examples of the user information include the user's name, address, phone number, sex, date of birth, email address, password, biometric information (face image; face photo, face authentication data), passport information, name on a receipt, and the like. The user operates the terminal 40 to register information about the reserved hotel (hotel information; for example, the name of the hotel) and the user information (face image, name, etc.) in the authentication server 10 (see FIG. 7). The email address and password are necessary information to access the system user account. For example, email addresses are treated as member IDs. Note that the creation of system user accounts and so on are obvious to those skilled in the art, so the description of such processing is omitted.

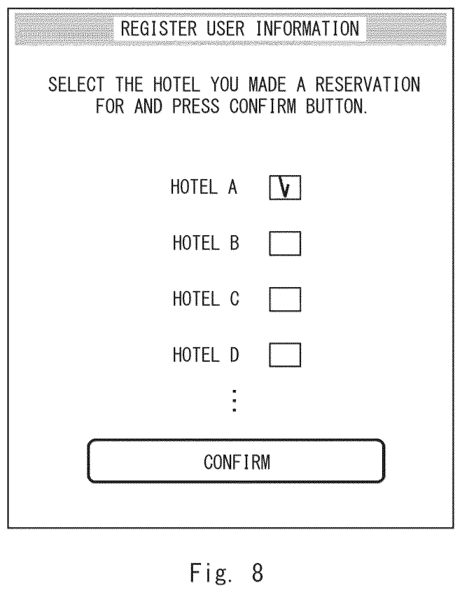

When the user registration app is started, the terminal 40 displays a GUI as shown in FIG. 8. The user who is in contact with the GUI as shown in FIG. 8 operates the terminal 40 to select the hotel for which the reservation has been completed.

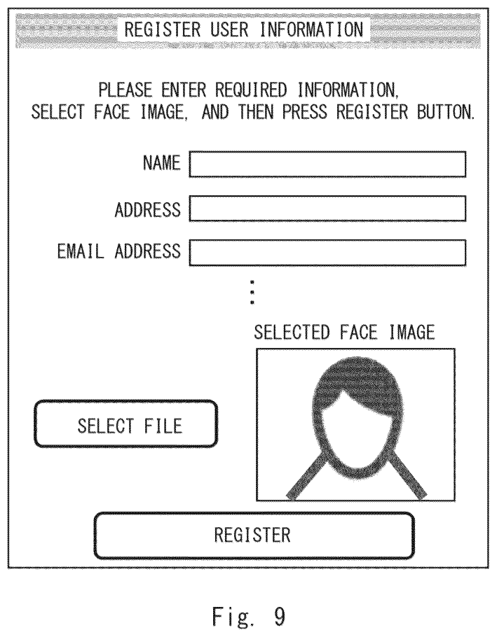

When the hotel is selected, the terminal 40 displays a GUI as shown in FIG. 9. The user operates the terminal 40 and registers user information (name, address, email address, face image, etc.) in the authentication server 10. The user information registered by the user in the authentication server 10 shall include user identification information for identifying the user (reserving person) in the authentication system. Example of the user identification information include the reserving person's name and email address. Hereinafter, the registered email address will be treated and described as the user identification information.

The authentication server 10 that has acquired the face image generates feature quantities (feature vector) from the face image and stores it in association with a name, an address, an email address, a hotel ID, and the like. The authentication server 10 stores the biometric information (feature quantity), name, address, email address, hotel ID, and the like in an authentication information database in association with each other.

The hotel ID is an identifier that uniquely identifies a hotel (accommodation provider). The hotel ID corresponds to the provider ID mentioned above. The authentication server 10 stores the hotel ID of the hotel selected by the user through the GUI shown in FIG. 8 in association with the name, address, email address, biometric information, etc.

### [Hotel Use]

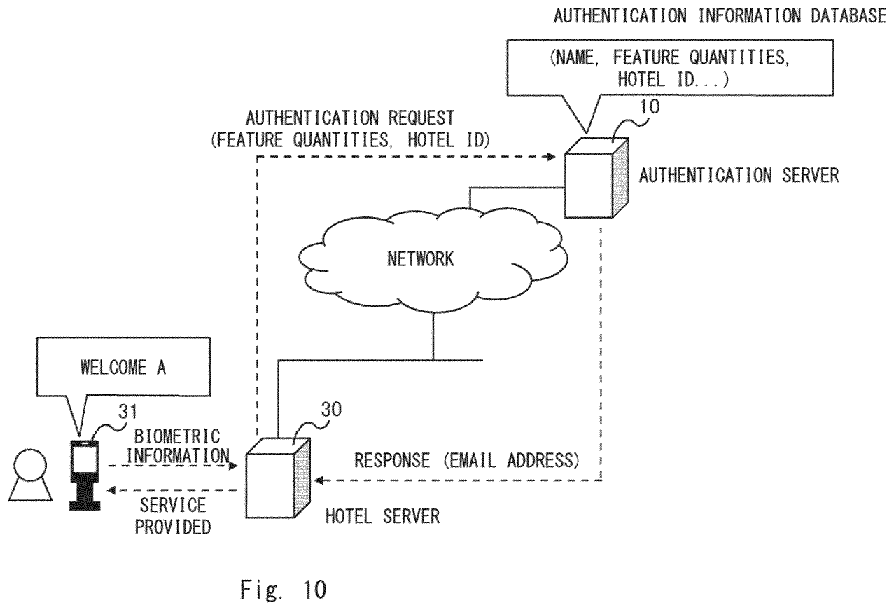

After the user registration is completed by using the user registration app, the user can receive the services using the biometric authentication from the hotel for which the reservation is made. Here, a case where the user visits the hotel and the check-in procedure is performed by using the biometric authentication is described with reference to FIG. 10.

The user moves to the front of the authentication terminal 31 installed in the hotel for which the reservation is made.

The authentication terminal 31 acquires the biometric information from the user in front of it. Specifically, the authentication terminal 31 captures an image of the user and acquires a face image. The authentication terminal 31 transmits the acquired face image to the hotel server 30.

The hotel server 30 generates the feature quantities from the acquired face image. The hotel server 30 transmits an authentication request including the generated feature quantities and the hotel ID to the authentication server 10.

The authentication server 10 performs matching processing (1-to-N matching; N is a positive integer, the same shall apply hereinafter) by using the feature quantities included in the authentication request and the feature quantities registered in the authentication information database.

The authentication server 10 determines that the authentication has succeeded when the hotel reserved by the user identified by the matching processing matches the hotel a person being authenticated (the user whose biometric information has been acquired by the authentication terminal 31) has visited.

In other words, the authentication server 10 determines that the authentication has failed when the user is not identified by the matching processing (the biometric information of the person being authenticated is not stored in the authentication information database) or when the hotels do not match (when two hotel IDs do not match).

Upon successful authentication, the authentication server 10 transmits an acknowledgement including the user identification information (email address) of the person being authenticated to the hotel server 30.

When the authentication fails, the authentication server 10 transmits a negative-acknowledgement to the hotel server 30 indicating a failure.

The hotel server 30 identifies the reservation information based on the acquired user identification information (email address). The hotel server 30 performs the check-in procedure for the user based on the identified reservation information. Although the case where the check-in procedure is performed using the biometric authentication has been described with reference to FIG. 10, the check-out procedure, the unlocking of the guest room and the control of the lock may be performed using the biometric authentication.

Next, details of each apparatus included in the authentication system according to the first example embodiment are described.

### [Authentication Server]

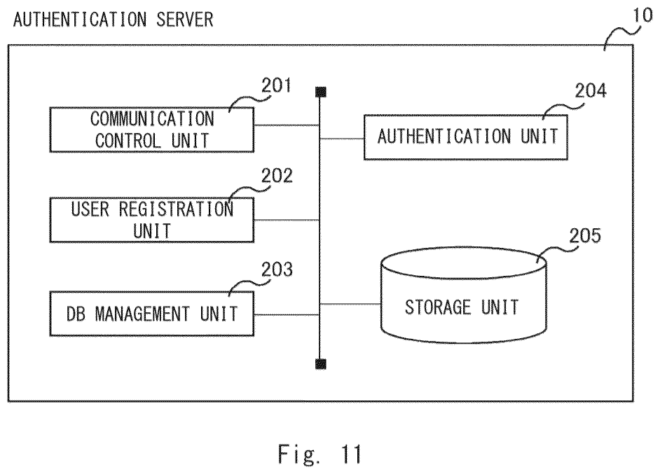

FIG. 11 shows an example of a processing configuration (processing module) of the authentication server 10 according to the first example embodiment. As shown in FIG. 11, the authentication server 10 includes a communication control unit 201, a user registration unit 202, a database management unit 203, an authentication unit 204, and a storage unit 205.

The communication control unit 201 is means for controlling communication with other apparatuses. For example, the communication control unit 201 receives data (packets) from the hotel server 30. The communication control unit 201 also transmits data to the hotel server 30. The communication control unit 201 passes the data received from other apparatuses to other processing modules. The communication control unit 201 transmits data acquired from other processing modules to other apparatuses. In this way, the other processing modules transmit and receive data to and from other apparatuses via the communication control unit 201.

The user registration unit 202 is means for achieving user registration of hotel reserving persons. The user registration unit 202 acquires hotel information (hotel name) related to the hotel for which the reserving person has made a reservation, biometric information (face image), name, address, email address, etc., of the hotel reserving person.

In response to the access of the user registration app to the authentication server 10, the user registration unit 202 displays a GUI or an input form on the terminal 40 that enables the user to select a hotel for which the user wishes to make a reservation. For example, the user registration unit 202 displays a GUI as shown in FIG. 8 on the terminal 40.

When the information about the hotel reserved through the GUI is acquired, the user registration unit 202 acquires the biometric information, name, address, email address, etc. of the user. For example, the user registration unit 202 displays a GUI or an input form for acquiring the above information on the terminal 40. For example, the user registration unit 202 displays a GUI as shown in FIG. 9 on the terminal 40.

When the user information (face image, name, address, email address, etc.) is acquired by, for example, a GUI as shown in FIG. 9, the user registration unit 202 generates the feature quantities (feature vector composed of a plurality of feature quantities) from the face image.

Specifically, the user registration unit 202 retrieves feature points from the acquired face image. Note that an existing technique can be used for the processing of extracting the feature points, and thus a detailed description of this processing is omitted. For example, the user registration unit 202 retrieves eyes, nose, mouth, and so on as the feature points from the face image. After that, the user registration unit 202 calculates the positions of the feature points and the distances between the feature points as the feature quantities, and generates the feature vector (vector information that characterizes the face image) composed of the plurality of feature quantities.

The user registration unit 202 passes to the database management unit 203 the name of the hotel reserved, the name, address, and the email address of the reserving person, and the feature quantities generated as above. When the user registration is performed correctly, the user registration unit 202 transmits an acknowledgement to the terminal 40. When the user registration is not performed correctly, the user registration unit 202 transmits a negative-acknowledgement to the terminal 40. For example, the negative-acknowledgement is transmitted to the terminal 40 when feature quantities satisfying a predetermined standard cannot be retrieved from the face image acquired from the user.

The database management unit 203 is means for managing the authentication information database. The authentication information database stores names, addresses, email addresses, biometric information (feature quantities) of users, hotel IDs of reserved hotels and so on in association with each other.

The database management unit 203 can obtain the hotel ID by referring to table information in which the hotel names are associated with the hotel IDs. A system administrator or the like may determine the hotel ID in advance, or an IP (Internet Protocol) address or a MAC (Media Access Control) address of the hotel server 30 may be used as the hotel ID.

The system administrator generates the above table information (table information in which the hotel names are associated with the hotel IDs) and registers it in the authentication server 10. The hotel IDs are also registered in the hotel server 30 of each hotel. That is, the authentication server 10 and the hotel server 30 share the hotel ID.

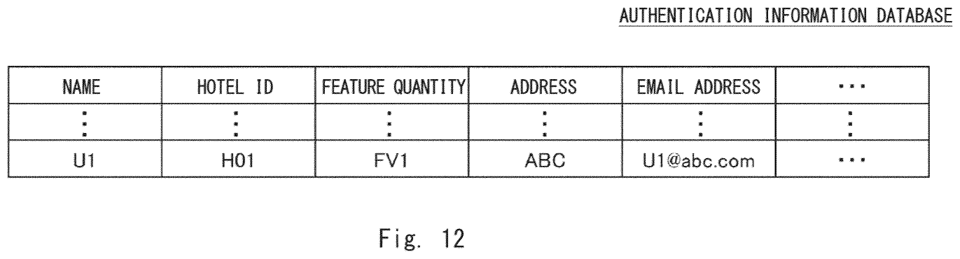

When the database management unit 203 acquires the above information (hotel name, name, address, email address, features quantities, etc.) from the user registration unit 202, it adds a new entry to the authentication information database. For example, when the above information about the user U1 is acquired, the database management unit 203 adds the entry shown in the bottom row of FIG. 12.

In this way, the authentication information database stores a first operator ID (first hotel ID), biometric information, name, address, email address (user identification information), etc. of the hotel (service provider) for which the user has made a reservation in association with each other.

The authentication information database shown in FIG. 12 is an example, and is not intended to limit the information stored in the authentication information database. For example, the face image may be registered in the authentication information database instead of the feature quantities for authentication. That is, at each authentication, the feature quantities may be generated from the face image registered in the authentication information database. Alternatively, the authentication information database may store a reservation ID or the like that identifies a hotel reservation.

The authentication unit 204 is means for performing user authentication processing. The authentication unit 204 processes the authentication request received from the hotel server 30. The authentication unit 204h performs biometric authentication using the biometric information included in the authentication request, and when authentication is successful, notifies the hotel server 30 of the user identification information (email address) of the person who has been successfully authenticated.

The authentication unit 204 retrieves the feature quantities and the hotel ID included in the authentication request. That is, since the hotel server 30 transmits an authentication request including a second operator ID (second hotel ID) of the provider (accommodation provider) managing this hotel server 30 and biometric information of a person being authenticated to the authentication server 10, the authentication unit 204 retrieves these pieces of information from the authentication request.

The authentication unit 204 sets the feature quantities retrieved from the authentication request as the feature quantities used for matching processing and the feature quantities stored in the database as the feature quantities to be registered, and performs 1-to-N matching. Specifically, the authentication unit 204 calculates the degree of similarity between the feature quantities used for the matching processing and each of the plurality of the feature quantities to be registered. A chi-square distance, a Euclidean distance or the like, can be used for calculating the degree of the similarity. Note that the greater the distance, the lower the degree of the similarity, whereas the smaller the distance, the higher the degree of the similarity.

The authentication unit 204 determines whether there are feature quantities registered in the database whose degree of the similarity to the feature quantities used for the matching processing is greater than or equal to a predetermined value. If such feature quantities are not present, the authentication unit 204 determines that authentication has failed.

When the feature quantities as described above are present, the authentication unit 204 identifies the entry with the highest degree of similarity (the entry in the authentication information database). The authentication unit 204 reads the hotel ID from the hotel ID field of the identified entry.

The authentication unit 204 determines whether or not the read hotel ID matches the hotel ID included in the authentication request.

If the hotel ID read from the database does not match the hotel ID in the authentication request, the authentication unit 204 determines that authentication of the person being authenticated has failed. For example, two hotel IDs do not match, for example, in a case where, even though the user visits a hotel for which he/she has not made a reservation, the biometric information of the user is registered in the authentication server 10. In this case, the authentication unit 204 determines that the authentication of the certified person has failed.

When the two hotel IDs match, the authentication unit 204 determines that the authentication of the person being authenticated has been successful. Thus, when the two hotel IDs match and processing for matching the biometric information included in the authentication request with the biometric information acquired from the terminal 40 (the biometric information stored in the authentication information database) is successful, the authentication unit 204 determines that the biometric authentication is successful.

The authentication unit 204 transmits the authentication result to the hotel server 30. When the authentication fails, the authentication unit 204 transmits a negative-acknowledgement to the hotel server 30 indicating a failure.

When the authentication is successful, the authentication unit 204 reads the email address of the person who has successfully been authenticated (the person who is determined to have been successfully authenticated) from the authentication information database, and transmits an acknowledgement including the email address to the hotel server 30.

The storage unit 205 stores information necessary for the operation of the authentication server 10. The authentication information database is built on the storage unit 205.

### [Hotel Server]

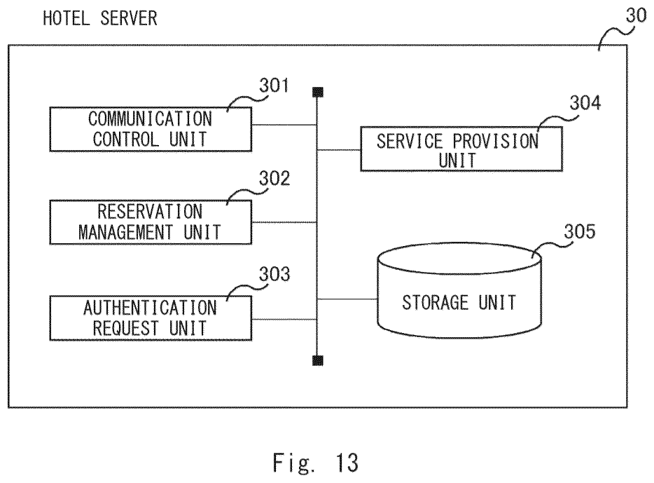

FIG. 13 shows an example of the processing configuration (processing module) of the hotel server 30 according to the first example embodiment. With reference to FIG. 13, the hotel server 30 includes a communication control unit 301, a reservation management unit 302, an authentication request unit 303, a service provision unit 304, and a storage unit 305.

The communication control unit 301 is means for controlling communication with other apparatuses. For example, the communication control unit 301 receives data (packets) from the authentication server 10. The communication control unit 301 also transmits data to the authentication server 10. The communication control unit 301 passes the data received from other apparatuses to other processing modules. The communication control unit 301 transmits data acquired from other processing modules to other apparatuses. In this way, the other processing modules transmit and receive data to and from other apparatuses via the communication control unit 301. The communication control unit 301 functions as an acquisition unit for acquiring reservation information related to a reservation for a service (e.g., accommodation services) provided by using the biometric authentication from the terminal 40. Alternatively, the communication control unit 301 functions as a reception unit for receiving information and a transmission unit for transmitting information.

The reservation management unit 302 is means for managing the reservation information of users. In response to access from the terminal 40, the reservation management unit 302 displays a GUI for acquiring the reservation information, the input form and the like on the terminal 40.

For example, the reservation management unit 302 acquires the reservation information using a GUI as shown in FIG. 5.

Based on the acquired reservation information and the reservation information registered in the reservation information database, the reservation management unit 302 determines whether or not to accept the user's reservation. For example, if there is a vacancy on the user's desired date of stay or in the user's desired guest room, the reservation management unit 302 accepts the reservation. For example, if there is no vacancy on the user's desired date of stay or in the user's desired guest room, the reservation management unit 302 rejects the reservation.

When the reservation is accepted, the reservation management unit 302 adds the acquired reservation information to a new entry in the reservation information database.

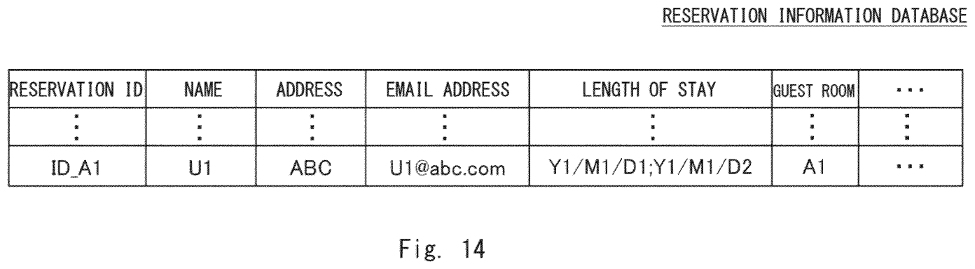

FIG. 14 shows an example of the reservation information database. As shown in FIG. 14, the reservation information database includes fields for storing the reservation ID, personal information about the reserving person (e.g., name, address, and email address), length of stay, guest room, and so on. The reservation ID is numbered when a new entry is added to the reservation information database. The reservation information about the user is uniquely identified by the reservation ID.

The reservation information database shown in FIG. 14 is an example and not intended to limit the information stored in the reservation information database. For example, credit information (information about a user's bank account or credit card) required for payment processing at check-out may be registered in the reservation information database.

The reservation management unit 302 notifies the terminal 40 of a result of the examination (acceptance or rejection) on the reservation. When a reservation is rejected, the reservation management unit 302 notifies the terminal 40 to that effect.

When a reservation is accepted, the reservation management unit 302 transmits the reservation completion notice including the user registration app introduction information (URL of the download site) to the terminal 40. As described above, the user registration app installation information is related to the installation of the user registration app on the terminal 40.

The hotel employee sets the user registration app introduction information (URL) in the hotel server 30 in advance. Alternatively, the reservation management unit 302 may inquire the Web server 20 about the URL of the download site of the user registration app periodically or at a predetermined timing. By acquiring the URL through such an inquiry, the reservation management unit 302 can acquire the latest correct URL.

As described above, the reservation management unit 302 determines whether or not to accept a reservation for a service from the user based on the reservation information acquired from the terminal 40. When the reservation management unit 302 accepts the reservation for the service, it transmits the reservation completion notice including the introduction information for application (introduction information about installation of the user registration app to register information required for the biometric authentication) to the terminal 40.

The authentication request unit 303 is means for requesting authentication of the user to the authentication server 10.

When the authentication request unit 303 acquires the biometric information (face image) from the authentication terminal 31, it generates the feature quantities from the face image. The authentication request unit 303 transmits an authentication request including the generated feature quantities and the hotel ID to the authentication server 10.

When the response from the authentication server 10 is a negative-acknowledgement (authentication failure), the authentication request unit 303 notifies the user to that effect through the authentication terminal 31. For example, in this case, the authentication request unit 303 outputs a message from the authentication terminal 31 asking for the person who has failed the authentication to visit a manned counter.

When the response from the authentication server 10 is an acknowledgement (successful authentication), the authentication request unit 303 retrieves the user identification information (email address) included in the response from the authentication server 10. The authentication request unit 303 passes the retrieved user identification information to the service provision unit 304.

The service provision unit 304 is means for providing services to users. The service provision unit 304 identifies reservation information stored in the reservation information database based on the user identification information (email address) acquired from the authentication request unit 303.

The service provision unit 304 performs check-in and check-out procedures using the identified reservation information. Alternatively, the service provision unit 304 may control unlocking and locking of a guest room (reserved guest room). Note that the check-in procedure and the like performed by the service provision unit 304 can be the same as the existing procedure and are obvious to those skilled in the art, so detailed descriptions of such procedures is omitted.

The storage unit 305 stores information necessary for the operation of the hotel server 30. The reservation information database is built on the storage unit 305.

### [Authentication Terminal]

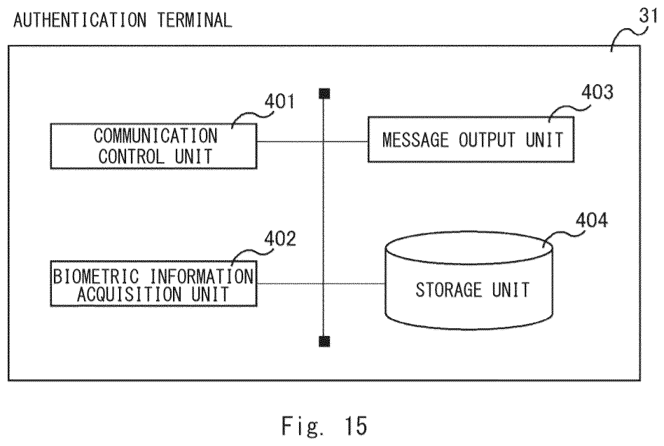

FIG. 15 shows an example of a processing configuration (processing module) of the authentication terminal 31 according to the first example embodiment. With reference to FIG. 15, the authentication terminal 31 includes a communication control unit 401, a biometric information acquisition unit 402, a message output unit 403, and a storage unit 404.

The communication control unit 401 is means for controlling communication with other apparatuses. For example, the communication control unit 401 receives data (packets) from the hotel server 30. The communication control unit 401 also transmits data to the hotel server 30. The communication control unit 401 passes the data received from other apparatuses to other processing modules. The communication control unit 401 transmits data acquired from other processing modules to other apparatuses. In this way, the other processing modules transmit and receive data to and from other apparatuses via the communication control unit 401.

The biometric information acquisition unit 402 controls the camera and acquires the biometric information (face image) of the user. The biometric information acquisition unit 402 captures an image of an area in front of the authentication terminal 30 in which this biometric information acquisition unit 402 is included. The biometric information acquisition unit 402 determines whether a person's face image is included in the acquired image, and if so, retrieves the face image from the acquired image data.

Note that existing techniques can be used for face image detection processing and face image extraction processing to be performed by the biometric information acquisition unit 402, so detailed descriptions of the face image detection processing and face image extraction processing is omitted. For example, the biometric information acquisition unit 402 may extract a face image (face area) from the image data using a training model learned by a CNN (Convolutional Neural Network). Alternatively, the biometric information acquisition unit 402 may extract the face image using a technique such as template matching.

The biometric information acquisition unit 402 transmits the retrieved face image to the hotel server 30.

The message output unit 403 is means for outputting various messages to users. For example, the message output unit 403 outputs a message about the user's authentication result or a message about service provision. The message output unit 403 may display a message using a display apparatus such as a liquid crystal monitor, or may play an audio message using an acoustic apparatus such as a speaker. The message output unit 403 only needs to acquire the details of the message to be output from the hotel server 30.

The storage unit 404 stores information necessary for the operation of the authentication terminal 31.

### [Terminal]

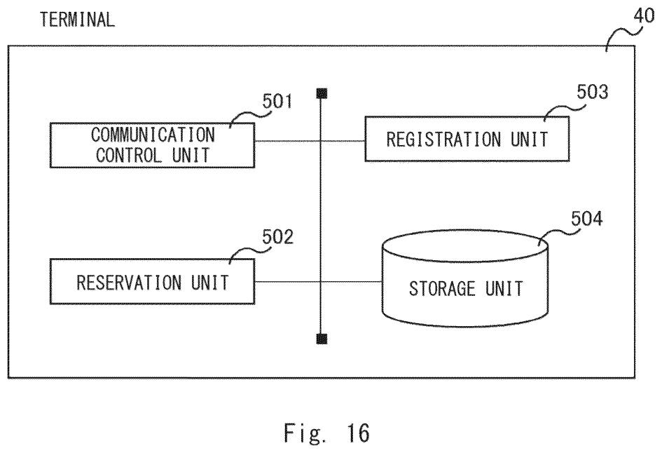

FIG. 16 shows an example of the processing configuration (processing module) of the terminal 40 according to the first example embodiment. Referring to FIG. 16, the terminal 40 includes a communication control unit 501, a reservation unit 502, a registration unit 503, and a storage unit 504.

The communication control unit 501 is means for controlling communication with other apparatuses. For example, the communication control unit 501 receives data (packets) from the hotel server 30. The communication control unit 501 also transmits data to the hotel server 30. The communication control unit 501 passes the data received from other apparatuses to other processing modules. The communication control unit 501 transmits data acquired from other processing modules to other apparatuses. In this way, the other processing modules transmit and receive data to and from other apparatuses via the communication control unit 501.

The reservation unit 502 is means for making hotel reservations. The reservation unit 502 displays a list of hotels participating in the system in response to the user's operation (see FIG. 4).

The user browses the list and select the hotel he/she wishes to make a reservation. The reservation unit 502 acquires information (hotel name) about the hotel for which the reservation is made.

The reservation unit 502 accesses the server of the hotel operated and managed by the hotel for which the reservation is made. For example, when the hotel A is selected as a hotel for which a reservation is to be made, the reservation unit 502 accesses the hotel server 30.

The reservation unit 502 cooperates with the hotel server 30 to acquire the reservation information from the user. For example, the reservation unit 502 acquires the reservation information by using a GUI as shown in FIG. 5. The reservation unit 502 transmits the acquired reservation information to the hotel server 30.

When the reservation is accepted, the reservation unit 502 receives a reservation completion notice (reservation completion email) from the hotel server 30. The reservation unit 502 displays the details of the reservation completion notice (see FIG. 6).

When a user who is in contact with the GUI as shown in FIG. 6 desires to install the user registration app, the reservation unit 502 accesses the download site of the app according to the user registration app introduction information (URL of the download site).

The reservation unit 502 accesses the application download site (Web server 20) and acquires the user registration app. The reservation unit 502 installs the acquired user registration app.

In this way, when the user desires to install the user registration app, the reservation unit 502 acquires and installs the user registration app by using the introduction information about the application included in the reservation completion notice.

The registration unit 503 is means for registering (inputting) information necessary for receiving services using the biometric authentication in the authentication server 10. The registration unit 503 starts an operation when the user registration app is started. When the user registration app is started, the registration unit 503 accesses the authentication server 10.

The registration unit 503, in cooperation with the authentication server 10, acquires the hotel ID of the hotel reserved by the user, biometric information (face image), name, address, email address, etc.

For example, the registration unit 503 displays a GUI as shown in FIG. 8 and acquires information about the hotel reserved by the user. After that, the registration unit 503 displays a GUI as shown in FIG. 9 to acquire the biometric information, the name, the address, the email address, etc.

The registration unit 503 transmits the acquired hotel name, biometric information, name, address, email address, etc. to the authentication server 10.

The registration unit 503 outputs a message or the like according to the response (acknowledgement or negative-acknowledgement) from the authentication server 10. When an acknowledgement is received, the registration unit 503 notifies the user that the user registration has been performed normally. When a negative-acknowledgement is received, the registration unit 503 notifies the user that the user registration has not been processed normally.

The storage unit 504 stores information necessary for operating the terminal 40.

### [WEB Server]

Since the processing configuration of the Web server 20 is obvious to those skilled in the art, the description thereof is omitted. The Web server 20 only needs to be configured to transmit the user registration app to the terminal 40 when the terminal 40 accesses the download site (download page).

### [System Operation]

Next, the operation of the authentication system according to the first example embodiment is described. The operation will be described when services using the biometric authentication are provided to users. Descriptions of system operations related to hotel reservations, installing user registration apps and the like are omitted.

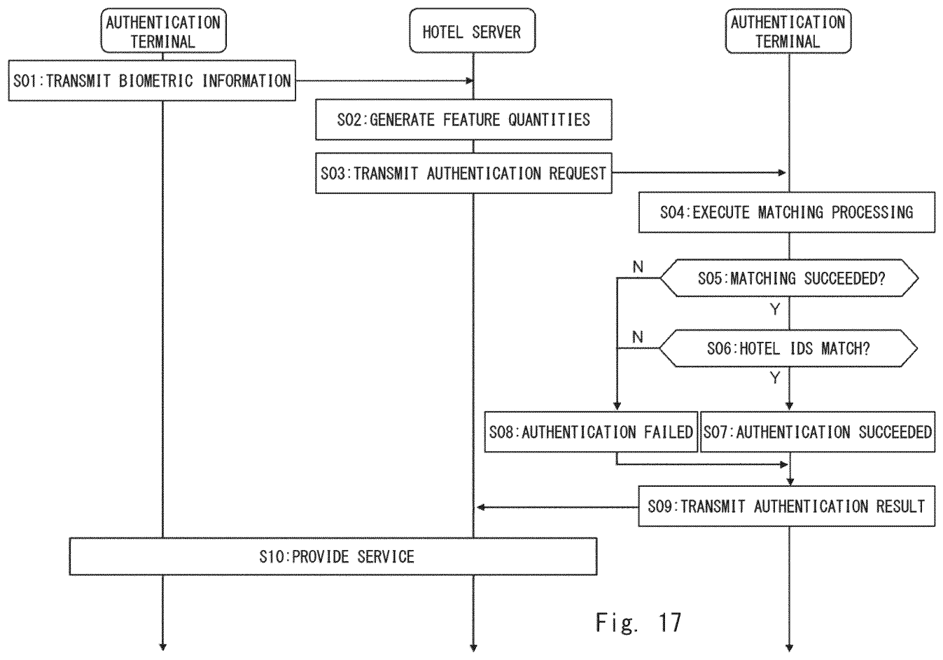

FIG. 17 is a sequence diagram showing an example of the operation of the authentication system according to the first example embodiment.

The authentication terminal 31 acquires the user's face image (biometric information) and transmits the acquired face image to the hotel server 30 (Step S01).

The hotel server 30 generates the feature quantities from the acquired face image (Step S02).

The hotel server 30 transmits an authentication request including the generated feature quantities and the hotel ID to the authentication server 10 (Step S03).

The authentication server 10 performs the matching processing using the feature quantities included in the authentication request and the hotel ID, and identifies the corresponding entry. Specifically, the authentication server 10 performs the processing for matching the feature quantities included in the authentication request with the feature quantities registered in the authentication information database (Step S04).

If the matching processing is successful (Step S05, Yes), the authentication server 10 determines whether or not the hotel ID of the entry identified by the matching processing matches the hotel ID retrieved from the authentication request (Step S06).

When the two hotel IDs match (Step S06, Yes), the authentication server 10 determines that the authentication is successful (Step S07).

If the matching processing fails (Step S05, No) or if the two hotel IDs do not match (Step S06, No), the authentication server 10 determines that the authentication has failed (Step S08).

The authentication server 10 transmits the authentication result to the hotel server 30 (Step S09). When the authentication server 10 notifies the hotel server 30 of the successful authentication, it transmits an acknowledgement including the user identification information (email address) to the hotel server 30 to identify the person being authenticated.

If the authentication is successful, the hotel (hotel server 30, authentication terminal 31) provides services to the person being authenticated (Step S10).

As described above, in the authentication system according to the first example embodiment, when a user completes a hotel reservation, the user is notified of the installation information related to the application for registering biometric information (user registration app). The user can install a necessary application on the terminal 40 according to the introduction information. That is, the user no longer needs to search for the above application on the network or install a wrong application.

### Second Example Embodiment

Next, a second example embodiment will be described in detail with reference to the drawings.

In the first example embodiment, when a user is registered in the authentication server 10, the user needs to select the hotel he/she has made a reservation from the list. Specifically, the user must operate the terminal 40 to select the hotel he/she has made a reservation from the GUI shown in FIG. 8.

In the second example embodiment, a case where it is not necessary for the above user to select the hotel for which he/she has made a reservation will be described. That is, in the second example embodiment, a case where the system automatically determines the information about the hotel reserved by the user without the user having to input the information of the hotel reserved by the user will be described.

The configuration of the authentication system according to the second example embodiment can be the same as the configuration of the authentication system according to the first example embodiment, and thus the description of the configuration thereof corresponding to the configuration in FIG. 2 is omitted. In addition, the processing configurations of the authentication server 10, the Web server 20, the hotel server 30, the authentication terminal 31, and the terminal 40 according to the second example embodiment can be the same as those according to the first example embodiment, and thus the descriptions of those components are omitted.

The differences between the first example embodiment and the second example embodiment are described below.

When the reservation management unit 302 of the hotel server 30 according to the second example embodiment accepts a reservation from a user, it transmits a reservation completion notice including the hotel ID of the hotel to the terminal 40 in addition to the reservation details and user registration app introduction information.

When the registration unit 503 of the terminal 40 according to the second example embodiment accesses the authentication server 10, it notifies the authentication server 10 of the hotel ID acquired from the hotel server 30.

The user registration unit 202 of the authentication server 10 according to the second example embodiment performs user registration using the acquired hotel ID. That is, the user registration unit 202 can know the hotel reserved by the user without having to acquire the information about the reserved hotel (the hotel ID of the reserved hotel) by using a GUI as shown in FIG. 8.

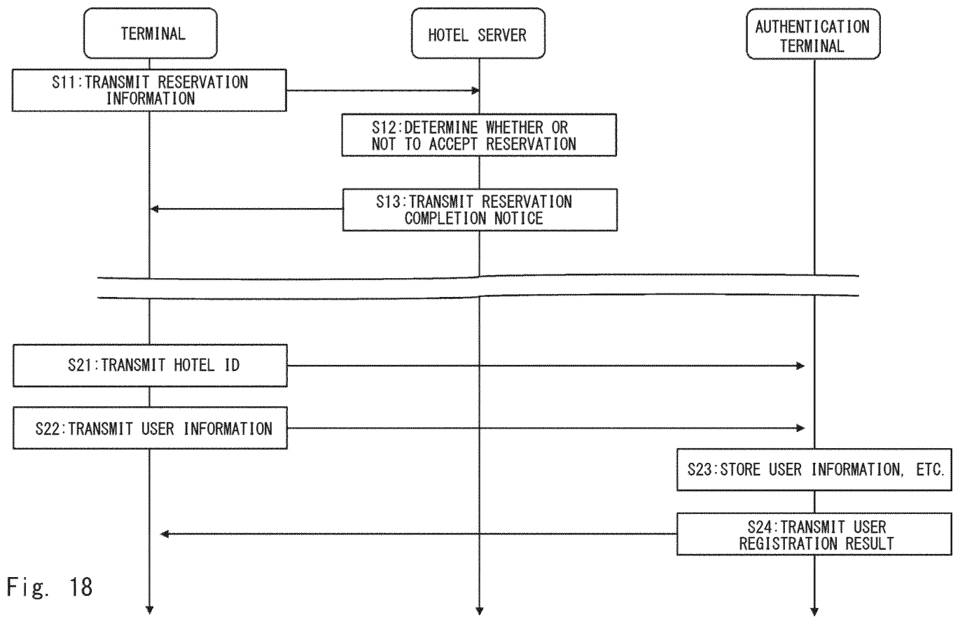

The operation of the above authentication system according to the second example embodiment is summarized as shown in the flowchart of FIG. 18.

The terminal 40 transmits the reservation information to the hotel server 30 (Step S11).

The hotel server 30 determines whether or not to accept the user's reservation (Step S12).

When the hotel server 30 determines to accept the reservation, it transmits the reservation completion notice including the hotel ID to the terminal 40 (Step S13).

When the terminal 40 registers a user, it transmits the hotel ID to the authentication server 10 (Step S21). The terminal 40 also transmits the user information (name, face image, etc.) to the authentication server 10 (Step S22).

The authentication server 10 stores names, addresses, email addresses, feature quantities generated from the face images, hotel IDs, and so on in association with each other (Step S23).

The authentication server 10 transmits a result of the user registration to the terminal 40 (Step S24).

As described above, in the authentication system according to the second example embodiment, since the hotel server 30 notifies the user of the hotel ID, the user does not need to input the information about the hotel he/she has made a reservation when he/she is registered. That is, the user's convenience is enhanced in the authentication system according to the second example embodiment.

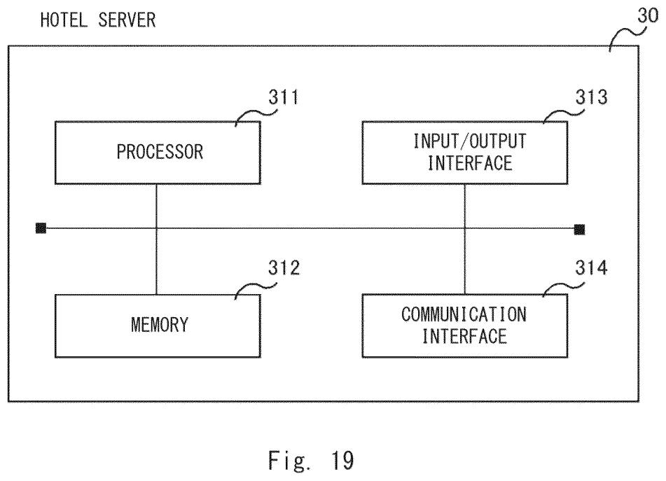

Next, hardware of each apparatus constituting the authentication system is described. FIG. 19 shows an example of the hardware configuration of the hotel server 30.

The hotel server 30 can be composed of an information processing apparatus (so-called computer) and has a configuration shown in FIG. 19. For example, the hotel server 30 includes a processor 311, a memory 312, an input/output interface 313, a communication interface 314, and so on. The components such as the processor 311 are connected by an internal bus or the like and configured to be able to communicate with each other.

However, the configuration shown in FIG. 19 is not intended to limit the hardware configuration of the hotel server 30. The hotel server 30 may include hardware not shown or may not include the input/output interface 313 as necessary. Also, the number of processors 311 and the like included in the hotel server 30 is not limited to the example shown in FIG. 19, and for example, a plurality of the processors 311 may be included in the hotel server 30.

The processor 311 is, for example, a programmable apparatus such as a CPU (Central Processing Unit), an MPU (Micro Processing Unit) or a DSP (Digital Signal Processor). Alternatively, the processor 311 may be an apparatus such as a Field Programmable Gate Array (FPGA) or an Application Specific Integrated Circuit (ASIC). The processor 311 executes various programs including an operating system (OS).

The memory 312 is a RAM (Random Access Memory), a ROM (Read Only Memory), an HDD (Hard Disk Drive), an SSD (Solid State Drive), or the like. The memory 312 stores an OS program, application programs, and various data.

The input/output interface 313 is an interface for a display apparatus or an input apparatus (not shown). The display apparatus is, for example, a liquid crystal display. The input apparatus, for example, accepts user operations such as an operation on a keyboard or mouse.

The communication interface 314 is a circuit, module or the like that communicates with other apparatuses. For example, the communication interface 314 includes a NIC (Network Interface Card) or the like.

The functions of the hotel server 30 are implemented by various processing modules. Each of the processing modules is implemented, for example, by the processor 311 executing a program stored in the memory 312. The program can also be recorded on a computer readable storage medium. The storage medium can be non-transitory, such as a semiconductor memory, hard disk, magnetic recording medium, or optical recording medium. That is, the present disclosure can also be embodied as a computer program product. The above program can be downloaded via a network or updated using a storage medium storing the program. Furthermore, the processing module may be implemented by a semiconductor chip.

Each of the authentication server 10, the Web server 20, the authentication terminal 31, the terminal 40, etc., can also be configured by an information processor in the same manner as the hotel server 30. Since the basic hardware configurations of those components are not different from that of the hotel server 30, the descriptions thereof are omitted. For example, the authentication terminal 31 may include a camera for capturing images of the user.

The hotel server 30 (server 100) is equipped with a computer. The functions of the hotel server 30 can be implemented by causing the computer to execute a program. The hotel server 30 also executes the method of controlling the hotel server 30 by the program.

### Modified Example

The configuration, operation and so on, of the authentication system described in the above example embodiments are examples and are not intended to limit the configuration and so on of the system.

In the above example embodiments, the case in which the authentication server 10 includes the authentication information database, and the hotel server 30 includes the reservation information database is described. However, these databases may be built on a different database server than the authentication server 10 or the hotel server 30. That is, the authentication system only needs to include various means (for example, means for managing reservations) described in the above example embodiments.

In the above example embodiments, the operation and the like of the authentication system is described by treating the accommodation provider operating the hotel as a service provider. However, the accommodation provider is an example of a service provider disclosed in the present application, and a service provider may be in another industry. For example, restaurants requiring reservations may participate in the authentication system. Alternatively, service providers from different industries such as accommodation providers and restaurants may participate in the authentication system.

The reservation completion notice (reservation completion email) transmitted from the hotel server 30 may contain introduction information about other applications in place of or in addition to the user registration app introduction information. For example, installation information (URL) about an application for inputting user's health information (body surface temperature, vaccination against infectious diseases, etc.) may be included in the reservation completion email. The user inputs his/her own health information using the app. The input health information is transmitted to the hotel server 30 of the reserved hotel and used to provide accommodation services. For example, the hotel server 30 may reject a user who has not been vaccinated and whose body surface temperature is high from checking in, even if the authentication is successful.

The applications provided to the user may vary according to the attributes of the user (reserving person). For example, the hotel server 30 may provide different applications depending on the region or nationality of the user. For example, the hotel server 30 may include, in the reservation management notice, information about introduction of the application for foreigners required for entry into Japan. For example, the information about introduction of the application that enables tracking of people affected by infectious diseases may be transmitted to the user at the time of making a reservation for a hotel or the like.

Alternatively, the applications provided to the user may vary depending on the location of the hotel. For example, the information about the introduction of the application convenient for sightseeing around the hotel A may be transmitted from the hotel A to the terminal 40, and information about the installation of another application convenient for sightseeing around the hotel B may be transmitted from the hotel B to the terminal 40.

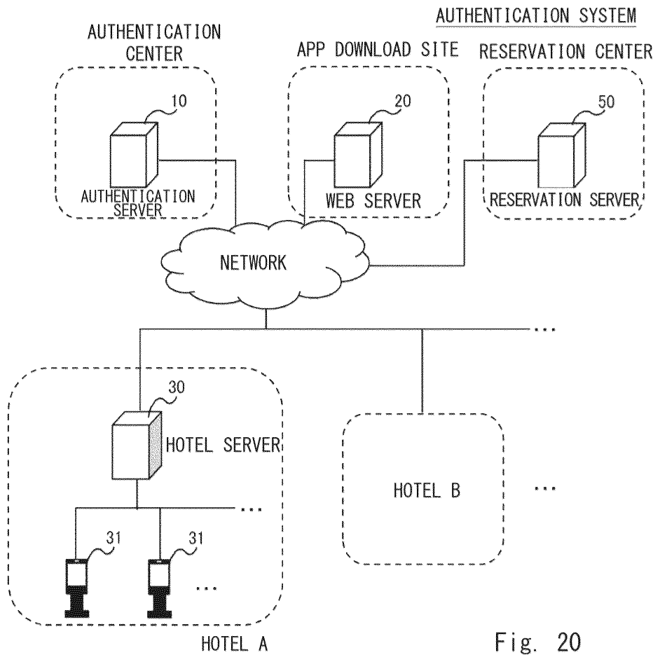

In the above example embodiments, the case in which the user selects a hotel where he/she desires to stay and then inputs reservation information has been described. However, a reservation center that accepts hotel reservations may be included in the authentication system (see FIG. 20). The reservation center may be operated by a union of accommodation provider or by a private company such as a travel agent. The user may make a hotel reservation as shown in FIG. 2 through the authentication center. Specifically, the user uses the terminal 40 to access a reservation server 50. The user inputs the hotel he/she desires to reserve and reservation information (name of the reserving person, length of stay, etc.) into the reservation server 50. The reservation server 50 transmits the acquired reservation information to the hotel server 30 of the hotel selected by the user. The hotel server 30 determines whether or not to accept the reservation and transmits a result of the determination to the reservation server 50. The reservation server 50 transmits a reservation completion notice including the user registration app introduction information to the terminal 40. By introducing the reservation server 50 into the system, the reservation information of users is centrally managed. Alternatively, the functions of the Web server 20 and the reservation server 50 may be integrated. In this case, the reservation server 50 including the functions of the Web server 20 may also transmit a reservation completion notice including an installation file and an execution file of the user registration app to the terminal 40.

In the above example embodiments, the case where the URL of the download site providing the app is used as the user registration app introduction information is described. However, the URL of the download site is an example, and is not intended to limit the user registration app introduction information. For example, the name of the user registration app may be included in the reservation completion notice and transmitted to the terminal 40. The terminal 40 displays the name of the user registration app. The user may reach the download site of the application by operating the terminal 40 and inputting the name in a search site on the Internet.

The displays of the GUI and the like described in the above example embodiments are examples, and is not intended to limit the interface provided to the user. For example, in FIG. 6, the terminal 40 may display the URL included in the reservation completion notice as it is instead of the “install” button. In this case, the terminal 40 may access the download site indicated in the URL when the user performs an operation such as touching or clicking the displayed URL.

In the above example embodiments, the case where the terminal 40 accesses the download site when the user desires to install the user registration app is described. However, if the user registration app is not installed on the terminal 40, the terminal 40 may automatically acquire and install the application.

The hotel server 30 may transmit a two-dimensional barcode or the like for check-in to the user whose reservation has been completed. That is, the service provider of the present disclosure may support both authentication using two-dimensional barcodes and authentication using biometric information.

In the above example embodiments, the case where the email address of the reserving person is used as the “user identification information” is described. However, other information may be used as the user identification information. For example, a passport number or driver's license number may be used as the user identification information. In this case, the user inputs the passport number or the like into the hotel server 30 when making a reservation for the hotel. Also at the time of user registration, the user inputs the passport number into the authentication server 10. Upon successful authentication of a person being authenticated, the authentication server 10 transmits an acknowledgement including the passport number to the hotel server 30. The hotel server 30 may identify the reservation information of the person being authenticated (the person who has been successfully authenticated) based on the passport number.

Alternatively, when the hotel server 30 transmits the reservation completion notice to the terminal 40, the reservation ID may be included in the notice. When the user is registered, he/she inputs the reservation ID he/she has been notified of into the authentication server 10. The authentication server 10 may include the above reservation ID in the acknowledgement when processing the authentication request and then transmits the acknowledgement. The hotel server 30 may identify the reservation information of the user based on the obtained reservation ID.

When a plurality of the Web servers 20 are included in the system, the hotel server 30 may include a plurality of URLs respectively corresponding to the plurality of Web servers 20 in the reservation completion notice and then transmits the reservation completion notice to the terminal 40. Alternatively, the hotel server 30 may select a URL so that the load on the Web server 20 side is distributed, and then transmit the reservation completion notice including the selected URL to the terminal 40.

The authentication server 10 may reuse the user information acquired from the same user. That is, instead of registering the biometric information, name and the like in the authentication server 10 every time a hotel reservation is made, a user may register biometric information, etc. in the authentication server 10 once and then need not re-enter the above information. For example, the user registration app acquires the user's face image at startup and transmits it to the authentication server 10. The authentication server 10 executes authentication processing using the acquired face image and the feature quantities registered in the authentication information database. When the authentication is successful, the authentication server 10 does not ask the user to input the biometric information or his/her name, and instead requests the information about the hotel for which the reservation has been made. When the authentication fails, the authentication server 10 requests the user (terminal 40) to input the name of the hotel reserved, the biometric information, the user's name and the like, as described in the above example embodiments.

The authentication server 10 or the hotel server 30 may verify the identity of the user and permit user registration or hotel reservations only for those users whose identities can be verified. In this case, the terminal 40 acquires the user's face image and the face image included in the identification document (for example, passport, driver's license) at the time of making a hotel reservation or user registration, and transmits them to the authentication server 10 and the hotel server 30. When the authentication server 10 and the hotel server 30 determine that the two face images are substantially the face images of the same person (when the one-to-one matching is successful), they determine that the identity of the user has been successfully verified.

In the above example embodiments, it has been described that the user identification information (email address) is transmitted from the authentication server 10 to the hotel server 30, and the user who visited the hotel is identified using the email address. However, if the authentication is successful, the authentication server 10 may transmit the information to be included in the registration card of the person being authenticated to the hotel server 30. Specifically, the user registers personal information (Name, email address, etc.) in the hotel server 30 when booking a hotel. The user starts the user registration app and registers the information included in the registration card (membership information; information including name, email address, etc.) in the application. Here, the email address at the time of making a reservation for the hotel is checked against the email address registered in the user registration app and then associated with each other. The authentication server 10 generates the registration card based on the member information registered in the user registration app. When the reserving person visits a hotel, a visitor is identified by biometrics authentication and the above generated registration card is transmitted to the hotel server 30. The hotel server 30 stores (registers) the received registration card.

In the above example embodiments, when the authentication request from the hotel server 30 is processed, the authentication server 10 determines that the authentication is successful if the matching processing is successful and the two hotel IDs match. However, the authentication server 10 may determine that the authentication is successful in response to that the matching processing is successful (the biometric information of the person being authenticated is registered in the authentication information database) without using the hotel ID. For example, this may be the case if only one accommodation provider participates in the system.

The plurality of authentication terminals 31 owned by the service provider (accommodation provider) need not to be installed on the same site, building, or the like. If service providers are common, each authentication terminal 31 may be installed physically separate from each other.

In the above example embodiments, the case where the biometric information pertaining to the “feature quantities generated from the face image” is transmitted from the hotel server 30 to the authentication server 10 is described. However, the biometric information pertaining to the “face image” may be transmitted from the hotel server 30 to the authentication server 10. In this case, the authentication server 10 only needs to generate the feature quantities from the acquired face image and execute the authentication processing (matching processing).

In the above example embodiments, the case where the authentication terminal 31 acquires the face image and the hotel server 30 generates the feature quantities from the face image is described. However, the authentication terminal 31 may generate the feature quantities from the face image and transmit the generated feature quantities to the hotel server 30. That is, the hotel server 30 need not to generate the feature quantities.

The form of data transmission and reception between apparatuses (authentication server 10, hotel server 30, authentication terminal 31) is not particularly limited, but data transmitted and received between these apparatuses may be encrypted. Between these apparatuses, the biometric information is transmitted and received, and it is desirable that encrypted data is transmitted and received in order to properly protect the biometric information.

In the flowchart used in the above description (flowchart, sequence diagram), a plurality of steps (processes) are described in order, but the order of executing the processes executed in the example embodiments is not limited to the order in which they are described. In the example embodiments, the order of the processes illustrated can be changed within a range that does not impair the content of the processes, such as executing each process in parallel.

The above example embodiments have been described in detail to facilitate understanding of the present disclosure and is not intended to require all of the configurations described above. When more than one example embodiments have been described, each of them may be used alone or in combination. For example, it is possible to replace part of the configuration of one of the example embodiments with the configuration of another one of the example embodiments, or to add the configuration of one of the example embodiments to the configuration of another one of the example embodiments. In addition, it is possible to add, remove, or replace other configurations for some of the configurations of the example embodiments.

While the industrial applicability of the present disclosure is obvious from the above description, the present disclosure is suitably applicable to authentication systems that authenticate customers such as retailers and hoteliers.

In the above example, the program can be stored and provided to the computer using any type of non-transitory computer readable media. Examples of non-transitory computer readable media include magnetic storage media. Examples of non-transitory computer readable media include magnetic storage media (e.g. floppy disks, magnetic tapes, hard disk drives, etc.), and optical magnetic storage media (e.g. magneto-optical disks). Examples of non-transitory computer readable media further include CD-ROM (Read Only Memory), CD-R, and CD-R/W. Examples of non-transitory computer readable media further include semiconductor memories. Examples of semiconductor memories include mask ROM, PROM (Programmable ROM), EPROM (Erasable PROM), flash ROM, RAM (Random Access Memory), etc. The program may be provided to the computer using any type of transitory computer readable media. Examples of transitory computer readable media include electric signals, optical signals, and electromagnetic waves. Transitory computer readable media can provide the program to the computer via a wired communication line (e.g. electric wires, and optical fibers) or a wireless communication line.

The whole or part of the example embodiments disclosed above can be described as, but not limited to, the following supplementary notes.

### [Supplementary Note 1]

A server comprising:
an acquisition unit configured to acquire, from a user's terminal, reservation information about a reservation for a service provided using biometric authentication; and
a reservation management unit configured to determine whether or not to accept the reservation for the service based on the reservation information, wherein
when the reservation management unit determines to accept the reservation for the service, the reservation management unit transmits, to the terminal, a reservation completion notice including introduction information about installation of an application for registering information necessary for the biometric authentication.

### [Supplementary Note 2]

The server according to Supplementary note 1, wherein the introduction information is a URL (Uniform Resource Locator) of a download site providing the application.

### [Supplementary Note 3]

The server according to Supplementary note 1 or 2, wherein
the application is used to register biometric information of the user in the authentication server performing the biometric authentication.

### [Supplementary Note 4]

The server according to any one of Supplementary notes 1 to 3, wherein
the reservation management unit transmits the reservation completion notice to the terminal, the reservation completion notice including an operator ID for identifying an operator providing the service.

### [Supplementary Note 5]

The server according to any one of Supplementary notes 1 to 4, wherein
the service provided using the biometric authentication is an accommodation service of an accommodation provider.

### [Supplementary Note 6]

A system comprising:
a terminal used by a user;
an authentication server configured to perform biometric authentication using biometric information; and
a server connected to the authentication server, wherein
the server comprises:
   an acquisition unit configured to acquire, from the user's terminal, reservation information about a reservation for a service provided using the biometric authentication; and
   a reservation management unit configured to determine whether or not to accept the reservation for the service based on the reservation information, and transmit, to the terminal, a reservation completion notice including introduction information about installation of an application for registering information necessary for the biometric authentication when the reservation for the service is accepted.

### [Supplementary Note 7]

The system according to Supplementary note 6, wherein
when the user desires to install the application, the terminal acquires the application using the introduction information included in the reservation completion notice.

### [Supplementary Note 8]

The system according to Supplementary note 6 or 7, wherein
when the application is started, the terminal accesses the authentication server, and
the authentication server acquires, from the terminal, the biometric information about the user and user identification information for identifying the user.

### [Supplementary Note 9]

The system according to Supplementary note 8, wherein
the server transmits an authentication request including the biometric information about a person being authenticated to the authentication server,
the authentication server performs the biometric authentication using the biometric information included in the authentication request, and when the authentication is successful, notifies the server of the user identification information, and
the server identifies the reservation information about the user who has made a reservation for the service by using the user identification information the server is notified of.

### [Supplementary Note 10]

The system according to Supplementary note 9, wherein
the authentication server stores a first operator ID of an operator for whom the user has made the reservation, the biometric information, and the user identification information in association with each other,
the server transmits the authentication request to the authentication server further including a second operator ID of an operator managing the server, and
the authentication server determines that the biometric authentication is successful when the first and second operator IDs match and processing for matching the biometric information included in the authentication request with the biometric information acquired from the terminal is successful.

### [Supplementary Note 11]

The system according to any one of Supplementary notes 6 to 10, wherein
the user identification information is an email address of the user who has made the reservation for the service.

### [Supplementary Note 12]

The system according to any one of Supplementary notes 6 to 11, wherein
the biometric information is a face image or a feature quantity generated from the face image.

### [Supplementary Note 13]

A method of controlling a server comprising:
acquiring, from a user's terminal, reservation information about a reservation for a service provided using biometric authentication;
determining whether or not to accept the reservation for the service based on the reservation information; and
transmitting, to the terminal, a reservation completion notice including introduction information about installation of an application for registering information necessary for the biometric authentication when the reservation for the service is accepted.

### [Supplementary Note 14]

A non-transitory computer readable medium storing a program for causing a computer mounted on a server to execute:
processing of acquiring, from a user's terminal, reservation information about a reservation for a service provided using biometric authentication; and
processing of determining whether or not to accept the reservation for the service based on the reservation information, and transmitting, to the terminal, a reservation completion notice including introduction information about installation of an application for registering information necessary for the biometric authentication when the reservation for the service is accepted.

Each disclosure of the above cited prior art documents shall be incorporated by reference in the present document. The example embodiments of the present disclosure have been described above, but the present disclosure is not limited to these example embodiments. It will be understood by those of ordinary skill in the art that these example embodiments are merely illustrative and that various modifications are possible without departing from the scope of the present disclosure. That is, it is obvious that the present disclosure includes all disclosures, including the scope of claims, and various modifications and changes that a person skilled in the art could make in accordance with technical ideas.

### REFERENCE SIGNS LIST

10 AUTHENTICATION SERVER
20 WEB SERVER
30 HOTEL SERVER
31 AUTHENTICATION TERMINAL
40 TERMINAL
50 RESERVATION SERVER
100 SERVER
101 ACQUISITION UNIT
102, 302 RESERVATION MANAGEMENT UNIT
201, 301, 401, 501 COMMUNICATION CONTROL UNIT
202 USER REGISTRATION UNIT
203 DB (DATA BASE) MANAGEMENT UNIT
204 AUTHENTICATION UNIT
205, 305, 404, 504 STORAGE UNIT
303 AUTHENTICATION REQUEST UNIT
304 SERVICE PROVISION UNIT
311 PROCESSOR
312 MEMORY
313 INPUT/OUTPUT INTERFACE
314 COMMUNICATION INTERFACE
402 BIOMETRIC INFORMATION ACQUISITION UNIT
403 MESSAGE OUTPUT UNIT
502 RESERVATION
503 REGISTRATION UNIT

1. A server comprising:
at least one memory storing instructions; and
at least one processor configured to execute the instructions to:
acquire, from a user's terminal, first reservation information about a reservation for a service provided using biometric authentication;
determine whether or not to accept the reservation for the service based on the first reservation information and second reservation information registered in a reservation information database;
in a case of accepting the reservation for the service, transmit, to the terminal, a reservation completion notice including introduction information about installation of an application for registering information necessary for the biometric authentication; and
select an additional application introduction information included in the reservation completion notice according to a status of the user.

2. The server according to claim 1, wherein the at least one processor is further configured to execute the instructions to select the additional application introduction information based on the user's language setting or nationality.

3. The server according to claim 1, wherein the at least one processor is further configured to execute the instructions to select the additional application introduction information based on location information indicating a location in which the service is provided.

4. The server according to claim 1, wherein the additional application introduction information includes an application introduction information about sightseeing around the location.

5. A method of controlling a server comprising:
acquiring, from a user's terminal, first reservation information about a reservation for a service provided using biometric authentication;
determining whether or not to accept the reservation for the service based on the first reservation information and second reservation information registered in a reservation information database;
in a case of accepting the reservation for the service, transmitting, to the terminal, a reservation completion notice including introduction information about installation of an application for registering information necessary for the biometric authentication; and
selecting an additional application introduction information included in the reservation completion notice according to a status of the user.

6. A non-transitory computer readable medium storing a program for causing a computer to:
acquire, from a user's terminal, first reservation information about a reservation for a service provided using biometric authentication;
determine whether or not to accept the reservation for the service based on the first reservation information and second reservation information registered in a reservation information database;
in a case of accepting the reservation for the service, transmit, to the terminal, a reservation completion notice including introduction information about installation of an application for registering information necessary for the biometric authentication; and
select an additional application introduction information included in the reservation completion notice according to a status of the user.
